(19) United States
(12) Patent Application Publication
(10) Pub. No.: US 2020/0212522 A1
(43) Pub. Date: Jul. 2, 2020

(54) HEAT DISSIPATING ELEMENT

(71) Applicant: SGL CARBON SE, Wiesbaden (DE)

(72) Inventors: Thomas Köck, Munich (DE); Werner Langer, Hegnenbach (DE)

(21) Appl. No.: 16/812,508

(22) Filed: Mar. 9, 2020

Related U.S. Application Data
(63) Continuation of application No. PCT/EP2018/074600, filed on Sep. 12, 2018.

(30) Foreign Application Priority Data
Sep. 12, 2017 (DE) 10 2017 216 105.1

(51) Int. Cl. H01M 10/659; H01M 10/625; H01M 10/613; H01M 10/6554

(52) U.S. Cl. CPC H01M 10/659; H01M 10/625; H01M 2220/20; H01M 10/6554; H01M 10/613

(57) ABSTRACT

A heat dissipating element contains graphite and a microencapsulated phase-change material (PCM). The heat dissipating element is provided with a Li-ion battery for a car, truck, or pedelec to control the temperature of the battery. The heat dissipating element allows the capacitance of the Li-ion battery to remain at a higher level and more energy to be available for heating the passenger compartment.

### CROSS REFERENCE TO RELATED APPLICATIONS

This application is a continuation application of international patent application PCT/EP2018/074600, filed Sep. 12, 2018, designating the United States and claiming priority from German patent application DE 10 2017 216 105.1, filed Sep. 12, 2017, and the entire content of both applications is incorporated herein by reference.

### TECHNICAL FIELD

The disclosure relates to a heat dissipating element and the use thereof for controlling the temperature of a Li-ion battery in a car, truck, or pedelec.

### BACKGROUND

Heat dissipating elements are used for Li-ion batteries in cars, trucks, or pedal electric cycles (“pedelecs”). However, Li-ion batteries have the problem that at low temperatures, such as those that occur in winter, one or more heating elements that preheat the Li-ion battery before start-up are always required. In addition, the capacitance of the Li-ion batteries decreases at low temperatures, and the charge time becomes longer. However, it is precisely at the beginning of a journey that a lot of energy is required both for controlling the temperature of the passenger compartment and for the journey itself. The heat dissipating elements used, which are made of aluminium or graphite materials, cannot maintain temperatures, with the result that the heat dissipating elements cool out together with the structure as a whole. In general, cooling using heat dissipating elements is described in EP2825611 A1, for example.

### SUMMARY

It is an object of the present disclosure to provide heating elements for Li-ion batteries that can stabilise the Li-ion battery at a set temperature and overcome the aforementioned drawbacks of the related art.

This object is achieved by the use of at least one heat dissipating element for controlling the temperature of a Li-ion battery in a car, truck, or pedelec, comprising graphite and microencapsulated phase-change material (PCM).

The heat dissipating elements are arranged in the Li-ion battery between the pouch cells, in such a way that, depending on the construction of the Li-ion battery, one or more heat dissipating elements are used.

Typically, the graphite is selected from the group consisting of natural graphite, synthetic graphite, expanded graphite, or mixtures thereof.

Conventionally, to produce expanded graphite having a vermiform structure, graphite, such as natural graphite, is mixed with an intercalate, such as nitric acid or sulphuric acid, and heat-treated at an increased temperature of for example 600° C. to 1200° C. (DE 10003927 A1).

Expanded graphite is a graphite that is expanded in the plane perpendicular to the hexagonal carbon layers by comparison with natural graphite, for example by a factor of 80 or more. As a result of the expansion, expanded graphite is distinguished by outstanding malleability and good meshability. Expanded graphite may be used in foil form, a foil having a density of 0.7 to 1.8 g/cm³ typically being used. A foil having this density range has thermal conductivities of 150 W/(m·K) to 500 W/(m·K). The thermal conductivity is determined by the Angstrom method (“Ångström's Method of Measuring Thermal Conductivity,” Amy L. Lytle; Physics Department, The College of Wooster, Thesis).

In the context of this disclosure, a phase-change material is understood to mean a material that is subject to a phase transition when heat is supplied or emitted. This may for example be a transition from the solid to the liquid phase or vice versa. While heat is supplied to or dissipated from the PCM, the temperature remains constant once the phase transition point is reached and until the material is fully converted. The heat supplied or dissipated during the phase transition that does not cause any temperature change in the material is referred to as latent heat.

Typically, the PCM is selected from the group consisting of a sugar alcohol, a paraffin, a wax, a salt hydrate, a fatty acid, typically from the group consisting of paraffin, salt hydrate and wax. As sugar alcohols, e.g., pentaerythritol, trimethylolethane, erythritol, xylitol, mannitol, and neopentyl glycol or any desired mixture thereof may be used. As paraffins, saturated hydrocarbons having a general total formula CₙH₂ₙ₊₂ may be used, where the number n may be between 18 and 32. The molar mass of paraffins of this type is thus between 275 and 600 grams per mol. As salt hydrates, calcium chloride hexahydrate, magnesium chloride hexahydrate, lithium nitrate trihydrate, and sodium acetate trihydrate may be used, for example. As fatty acids, e.g., capric acid, lauric acid, myristic acid, palmitic acid, and stearic acid or any desired mixture thereof may be used. The selection of the PCM depends on the temperature range during use of the Li-ion battery.

Typically, the PCM has a melting range between −20 and 130° C., more typically between −10 and 100° C., and particularly typically between 0 and 70° C. Using phase-change materials, temperature stabilisation in the melting range of less than −20° C. and greater than 130° C. can only be achieved through increased expense and weight. Moreover, these temperatures seldom occur, and so the available material is carried along almost exclusively without any functionality. To prevent this, the temperature range between −20° C. and 130° C. is selected. By selecting the appropriate PCM, the temperature of the Li-ion battery is stabilised; for example, the temperature can be stabilised to 6° C. during cooling at night.

With particularity, during slow cooling, at least part of the phase transition (typically the entire phase transition) of the PCM takes place in a temperature range of 20 to 0° C. This can be established calorimetrically by measuring and displaying the temperature in the heat dissipating element while the heat dissipating element is exposed in a calorimeter to an atmosphere of a defined temperature and this temperature is decreased continuously by 0.1 K/min, from 20 K above the melting point of the PCM (having the highest melting point) to a temperature 20 K below the melting point of the PCM (having the lowest melting point). The start and end of phase transitions (liquid to solid) can easily be established in the thermogram. Microencapsulated phase-change material (PCM) having a phase transition in this temperature range is available from Mikrotek Laboratories Inc., Dayton, Ohio 43459, and supplied under the designations MPCM 6 and MPCM 18. Using PCM of this type, further cooling of the battery of the parked vehicle is particularly efficiently delayed towards the end of the night and early in the morning. Thus, on many winter mornings, the PCM provides precisely the energy that would otherwise have to be supplied to the Li-ion battery before start-up by way of active supply of heat using heating elements.

This has the advantage that the battery does not cool as much during standstill, and this in turn causes the capacitance of the Li-ion battery to remain at a higher level and more energy to be available for example for heating the passenger compartment. Moreover, the battery, which remains at a high temperature as a result of the use of the phase-change material, can be charged more rapidly. Thus, ultimately, as a result of the present disclosure, a start-up state of the vehicle is achieved with a particularly high travel comfort, ease of charging and range of the vehicle, over the entire year, without additional energy having to be supplied externally for this purpose.

On typical winter days, even if the vehicle is not operated during the day, solar radiation alone causes at least partial melting of PCM, in such a way that it can act as a thermal buffer again during the following night.

A particularly typical use according to the disclosure leads to a reduction in the energy required for preheating the Li-ion battery if the automobile or truck or pedelec is greatly cooled, for example to a temperature in the range of −5° C. to 5° C.

The microencapsulated phase-change material (PCM) may comprise a plurality of PCMs having different melting or solidification ranges. During slow cooling, the phase transitions from liquid to solid (solidification) thus take place at different temperatures for each of the PCMs. Typically, in this case, at least part of each of at least two phase transitions takes place in the aforementioned temperature range of 20 to 0° C. Particularly typically, at least two phase transitions take place fully in the temperature range of 20 to 0° C. Typically, the temperature at which a PCM starts to solidify is at least 8 K higher than the temperature at which another PCM that solidifies at a lower temperature is fully solidified. This can also easily be read off from the thermogram.

The different PCMs are typically spatially separated from one another, for example in that they are present in different microcapsules.

It is also conceivable for not all of the PCMs to be microencapsulated.

Exemplary embodiments comprising PCMs having different melting ranges achieve the desired improvements in the start-up state of the vehicle for a wider bandwidth of different ambient temperatures. This is desirable because the minimum temperatures that are reached on winter nights may vary greatly from night to night.

According to the disclosure, the microencapsulated PCM has a size of ≤5 mm, typically ≤1 mm, particularly typically ≤100 μm.

If the particle sizes exceed 5 mm, there is a significant drop in the heat input into the capsule itself, and the PCM in the interior of the capsule only melts very slowly. This means that often not the entire heat capacity can be exploited. If the capsule is too small, this results in unfavourable behaviour of the PCM and the inactive capsule shell, and this in turn negatively influences the heat capacity.

Typically, the at least one heat dissipating element is formed as a plate or foil that comprises graphite and microencapsulated PCM or as a plate or foil comprising graphite and microencapsulated PCM, at least one layer comprising microencapsulated PCM being applied to the plate or foil.

Also typically, the at least one heat dissipating element is formed as a graphite foil or graphite plate and comprises at least one applied layer of microencapsulated PCM.

The different exemplary embodiments of the heat dissipating element may be used in any desired combination for controlling the temperature of a Li-ion battery.

Typically, the content of microencapsulated PCM, in the plate or foil comprising graphite, microencapsulated PCM and additionally binder, is 10% by weight to 98% by weight, typically 20% by weight to 80% by weight, particularly typically 45% by weight to 70% by weight.

For a content of less than 10% by weight microencapsulated PCM, only slight stabilisation, if any, of the temperature of the Li-ion battery is achieved through phase change. At more than 98% by weight, the thermal conductivity effect achieved through the graphite content in the heat dissipating element is very low.

According to the disclosure, the binder content in the plate, comprising graphite, microencapsulated PCM and additionally binder, is 2 to 30% by weight, typically 5 to 20% by weight. As a result of the binder content, the strength of the composite material can be increased, and the heat capacity is only slightly influenced. In a typical case, the heat capacity is only reduced by 10%.

According to the disclosure, the binder may be selected from the group consisting of epoxy resins (such as Araldite 2000 (2014)), phenol resins, silicone resins, acrylate resins, rubber (for example Litex SX1014), or thermoplastics.

Typically, the content of microencapsulated PCM, in the layer comprising microencapsulated PCM and additionally binder that is applied to the plate or foil comprising graphite and microencapsulated PCM, is 10 to 98% by weight, typically 15 to 95% by weight, particularly typically 30 to 88% by weight.

Typically, the content of microencapsulated PCM, in the layer comprising microencapsulated PCM and additionally binder that is applied to the graphite foil or graphite plate, is 10% by weight to 98% by weight.

At a microencapsulated PCM content of less than 10% by weight in the layer, only slight stabilisation, if any, of the temperature of the Li-ion battery is achieved through phase change. At a content of more than 98% by weight microencapsulated PCM in the layer, the stability of the layer cannot be ensured.

Typically, the binder content of the layer comprising microencapsulated PCM and additionally binder that is applied to the plate or foil comprising graphite and microencapsulated PCM is 1 to 40% by weight, typically 2 to 30% by weight, particularly typically 5 to 20% by weight.

Typically, the binder content of the layer comprising microencapsulated PCM and additionally binder that is applied to the graphite foil or graphite plate is 1 to 40% by weight, typically 2 to 30% by weight, particularly typically 5 to 20% by weight.

At less than 1% by weight binder, the binder content is no longer sufficient to provide strength, and at more than 40% by weight binder, the binder content is too high, and the heat capacity of the layer due to the microencapsulated PCM is negatively influenced.

In addition to the stated constituents of the plate, foil or layer, these may further contain a dispersant, the content being between 0 and 5% by weight. As a dispersant, polyvinyl pyrrolidone (PVP) may be used, for example.

To achieve the properties according to the disclosure of the layer, all combinations of the components of the layer may be selected. The binder content ensures a solid, compact layer, whereas if a high melting enthalpy is desired a correspondingly high microencapsulated PCM content is to be selected.

Depending on the application and the profile of requirements, it may be further necessary to mix in highly thermally conductive additives during the production of the plate or foil or the layer. These conductive additives may contain carbon nanotubes (CNTs), graphene, graphene oxide, or hexagonal boron nitride, for example.

The layer applied to the plate, foil, graphite plate, or graphite foil may equally be applied on one and on a plurality of faces of the plate, foil, graphite plate, or graphite foil.

Typically, the at least one layer comprising microencapsulated PCM has a thickness of <5 mm, typically 1 to 3 mm, particularly typically 100 to 500 μm. At a layer thickness greater than 5 mm, the layer thickness significantly negatively influences the flexibility of the composite. Moreover, problems occur with the adhesion of the coating to the carrier substrate.

According to the disclosure, the foil or graphite foil has a thickness of 10 μm to 1 mm, typically 25 to 500 μm, particularly typically 25 to 100 μm. At less than 10 μm, no significant effect due to the graphite foil occurs any longer.

Typically, the plate or graphite plate has a thickness of greater than 1 to 5 mm, typically 2 to 4 mm, particularly typically 2 to 3 mm. At more than 5 mm, the effect according to the disclosure is not achieved.

According to the disclosure, the thermal conductivity of the at least one heat dissipating element is above 150 W/(m·K).

A further aspect of the disclosure is a heat dissipating element that comprises graphite and microencapsulated PCM, the heat dissipating element being formed as a plate or foil and at least one layer comprising microencapsulated PCM being applied to the plate or foil.

### BRIEF DESCRIPTION OF THE DRAWINGS

In the following, the present disclosure is described, purely by way of example, by way of exemplary embodiments and with reference to the accompanying drawings. The disclosure is not limited by the drawings.

FIG. 1 is a cross section of a heat dissipating element;

FIG. 2 is a cross section of a heat dissipating element; and

FIG. 3 is a cross section of a heat dissipating element.

### DESCRIPTION OF EXEMPLARY EMBODIMENTS

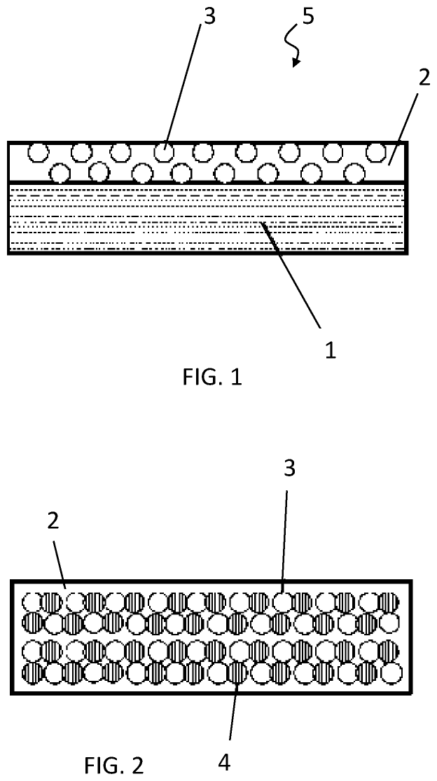

FIG. 1 shows a heat dissipating element containing a graphite foil (1) and a layer, applied thereto, of microencapsulated PCM (3) comprising a binder (2).

FIG. 2 shows a heat dissipating element as a plate containing graphite (4), microencapsulated PCM (3) and binder (2).

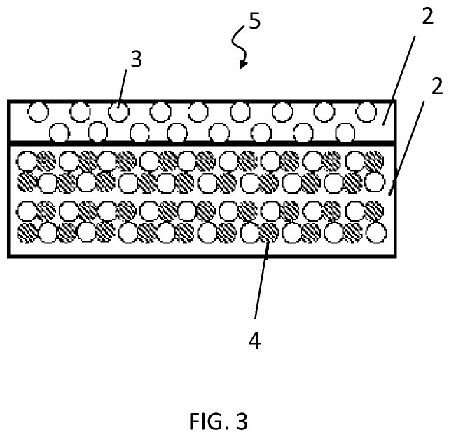

FIG. 3 shows a heat dissipating element as a plate containing graphite (4), microencapsulated PCM (3), and binder (2) and a layer, applied thereto, containing microencapsulated PCM (3) and binder (2).

In the following, the present disclosure is described by way of exemplary embodiments, the exemplary embodiments not forming any restriction on the disclosure.

### Exemplary Embodiment 1

A graphite foil having a thickness of 150 μm and a density of 1.3 g/cm³ (commercially available from SGL Carbon GmbH) is coated on one side with a mixture of microencapsulated PCM (Micronal 28, BASF), a rubber binder, and a dispersant.

The composition of the mixture is 24.5 g water, 1.5 g Litex SX 1014, 10.4 g microencapsulated PCM (Micronal 28, BASF), and 0.1 g polyvinyl pyrrolidone (PVP).

The mixture is dispersed in an ultrasonic bath and applied on a coating system using a doctor blade, blade height 500 μm. The result after drying is a 200 μm thin layer on the graphite foil.

### Exemplary Embodiment 2

A graphite foil having a thickness of 150 μm and a density of 1.3 g/cm³ (commercially available from SGL Carbon GmbH) is coated on both sides with a mixture of microencapsulated PCM (Micronal 28, BASF), 5 μm fine graphite powder, a rubber binder, and a dispersant.

The composition of the mixture is 31.5 g water, 2 g Litex SX 1014, 20 g graphite powder, 10.4 g microencapsulated PCM (Micronal 28, BASF), and 0.1 g polyvinyl pyrrolidone (PVP).

The mixture is dispersed in an ultrasonic bath and applied on a coating system at 55° C. using a doctor blade, blade height 600 μm. The result after drying is a 400 μm thin layer on the graphite foil.

### Exemplary Embodiment 3

A plate comprising microencapsulated PCM (Micronal 28, BASF) for use as a heat dissipating element. The composition of the plate is as follows: 135 g graphite powder (50 μm), 67.5 g graphite powder (150 μm), 810 g microencapsulated PCM (Micronal 28, BASF), 337.5 g Elastosil M4642A as a binder, and Elastosil M4642 B as a curing agent.

The individual mixture constituents are added in succession to an EIRICH mixer and mixed for a total of 10 minutes.

Subsequently, the raw compound is pressed into a 5 mm thick plate in a press.

### Exemplary Embodiment 4

A plate comprising microencapsulated PCM (Micronal 28, BASF) for use as a heat dissipating element. The composition of the plate is as follows: 135 g graphite powder (50 μm), 67.5 g graphite powder (150 μm), 810 g microencapsulated PCM (Micronal 28, BASF), 337.5 g Elastosil M4642A as a binder, and Elastosil M4642 B as a curing agent.

The individual mixture constituents are added in succession to an EIRICH mixer and mixed for a total of 10 minutes and pressed into a 5 mm thick plate.

Subsequently, the plate is coated on one side with a mixture of microencapsulated PCM (Micronal 28, BASF), a rubber binder, and a dispersant.

The composition of the mixture is 24.5 g water, 1.5 g Litex SX 1014, 10.4 g microencapsulated PCM (Micronal 28, BASF), and 0.1 g polyvinyl pyrrolidone (PVP).

The mixture is dispersed in an ultrasonic bath and applied on a coating system using a doctor blade, blade height 500 μm. The result after drying is a 200 μm thin layer.

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

### LIST OF REFERENCE NUMERALS

1 Graphite foil
2 Binder
3 Microencapsulated PCM
4 Graphite
5 Heat dissipating element

1. A method for controlling a temperature of a Li-ion battery in a car, a truck, or a pedelec, the method comprising:
providing at least one heat dissipating element containing a graphite and a microencapsulated phase-change material (PCM).

2. The method according to claim 1, wherein the graphite is selected from the group consisting of a natural graphite, a synthetic graphite, and an expanded graphite, or a mixture thereof.

3. The method according to claim 1, wherein the microencapsulated PCM is selected from the group consisting of a sugar alcohol, a paraffin, a wax, a salt hydrate, and a fatty acid, or a mixture thereof.

4. The method according to claim 1, wherein the microencapsulated PCM has a melting range between −20° C. and 130° C.

5. The method according to claim 4, wherein the microencapsulated PCM has a size of less than or equal to 5 mm.

6. The method according to claim 1, wherein the at least one heat dissipating element is configured as a plate or a foil, and wherein at least one layer comprising the microencapsulated PCM is provided on the plate or the foil.

7. The method according to claim 1, wherein the at least one heat dissipating element is configured as a graphite foil or a graphite plate and includes at least one applied layer of the microencapsulated PCM.

8. The method according to claim 6, wherein the at least one layer additionally comprises a binder, and wherein a content of the microencapsulated PCM in the at least one layer provided on the plate or the foil and comprising the graphite and the microencapsulated PCM is 10% to 98% by weight.

9. The method according to claim 7, wherein the at least one layer additionally comprises a binder, and wherein a content of the microencapsulated PCM in the at least one layer provided on the graphite foil or the graphite plate and comprising the graphite and the microencapsulated PCM is 10% to 98% by weight.

10. The method according to claim 6, wherein a thickness of the at least one layer comprising the microencapsulated PCM is less than 5 mm.

11. The method according to claim 6, wherein the plate has a thickness of more than 1 mm up to 5 mm.

12. The method according to claim 6, wherein the foil has a thickness of 10 μm to 1 mm.

13. The method according to claim 1, wherein a thermal conductivity of the heat dissipating element is above 150 W/(m·K).

14. A heat dissipating element provided for the method according to claim 1, wherein the heat dissipating element comprises graphite and microencapsulated PCM, wherein the heat dissipating element is configured as a plate or foil, and wherein at least one layer comprising the microencapsulated PCM is applied to the plate or the foil.

15. The method according to claim 1, wherein—during slow cooling—at least a part of the phase transition of the microencapsulated PCM takes place in a temperature range of 20° C. to 0° C.

16. The method according to claim 3, wherein the microencapsulated PCM has a melting range between −20° C. and 130° C.

17. The method according to claim 7, wherein a thickness of the at least one layer comprising microencapsulated PCM is less than 5 mm.

18. The method according to claim 7, wherein the graphite plate including the microencapsulated PCM has a thickness of more than 1 mm up to 5 mm.

19. The method according to claim 7, wherein the graphite foil has a thickness of 10 μm to 1 mm.
